(19) United States
(12) Patent Application Publication
(10) Pub. No.: US 2026/0297240 A1
(43) Pub. Date: Oct. 1, 2026

(54) PRE-TREATMENT OF POLYETHER POLYOLS OR SILICONE POLYETHER SURFACTANTS

(71) Applicant: DOW GLOBAL TECHNOLOGIES LLC, Midland, MI (US)

(72) Inventors: Zhengming Tang, Shanghai (CN); Jian Zou, Shanghai (CN); Tengfei Liu, Shanghai (CN); Haiying LI, Shanghai (CN); Shaoguang Feng, Shanghai (CN); Ping Zhang, Shanghai (CN)

(21) Appl. No.: 19/490,202

(22) PCT Filed: Aug. 31, 2023
(86) PCT No.: PCT/CN2023/116106

§ 371 Date: Dec. 4, 2025

(51) Int. Cl. C08G 18/48; C08G 18/16; C08G 18/76

(52) U.S. Cl. CPC C08G 18/4879; C08G 18/16; C08G 18/7621

(57) ABSTRACT

The present disclosure relates to low odor products and their use in polyurethane systems. The present disclosure provides a process of pre-treatment of an odorous product with an acidic agent with aldehyde abatement capability. The present disclosure also provides use of the pre-treated product in polyurethane systems.

### FIELD OF THE DISCLOSURE

The present disclosure relates to low odor products and their use in polyurethane systems. More particularly, the present disclosure relates to a process of pre-treatment of an odorous product, and the use of the pre-treated products in downstream applications such as polyurethane formulations. The pre-treatment provides a substantial reduction in odorous species in the pre-treated products and their downstream applications.

### BACKGROUND

For many years, cyclic ethers have been identified as very severe odorant in many systems including polyurethane foams, polyols, glycol type solvents and even natural river systems. Major cyclic ethers in polyurethane foams include trioxocane, 2-ethyl-4-methyl-1,3-dioxolane (2-EMD) and 2,4-dimethyl-1,3-dioxolane (2-DMD).

An analytical work performed with the objective of identifying the causes of musty odor in flexible polyurethane foam showed that trioxocane and its isomers are among the root causes of malodor (S. H. Harris et al., “Characterization of Polyurethane Foam Odor Bodies,” Polyurethanes World Congress 1987, Aachen, Germany, pages 848-851). This is surprising in consideration of the relatively high boiling point of trioxocane (220° C.), and it underlines the strong olfactory power associated with this type of molecules.

The undesired odor issue has become a long-standing industry challenge. People have some knowledge in how cyclic ethers are formed in a general way, but specifically for polyurethane systems, the understanding is quite limited, not to say solutions to overcome this challenge.

Thus, there is a need to address the undesired odor issue in polyurethane systems.

### SUMMARY OF THE DISCLOSURE

The present disclosure provides solutions to the above-identified issues and challenges.

In one aspect, the present disclosure provides a process of pre-treatment of an odorous product selected from the group consisting of a polyether polyol product, an SPE surfactant product, and a combination thereof, comprising, adding an acidic agent with aldehyde abatement capability to the product, wherein the acidic agent has the structure of formula (1):

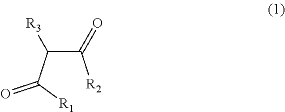

wherein R₁ and R₂ are individually selected from the group consisting of —OH, —NH, —NH₂, or a C₁₋₁₀ alkyl unsubstituted or substituted with at least one substituent selected from the group consisting of a halogen, —OH, —NH, —NH₂, —OSO₃H, —SO₃H, —COOH, —OPO(OH)₂, a C₁-C₆ alkyl, a C₁-C₆ alkoxy, and a C₃-C₆ alicyclic or aromatic ring whose carbon atom(s) is optionally replaced with at least one hetero atom selected from the group consisting of N, O and S; or optionally. R₁ and R₂ are linked by a single bond or a divalent linker group to form a cyclic structure;
with the proviso that at least one of R₁ and R₂ comprises at least one proton-releasing group selected from the group consisting of —OH, —NH, —NH₂, —OSO₃H, —SO₃H, —COOH, and —OPO(OH)₂; and, when the at least one proton-releasing group is —NH or —NH₂, it is adjacent to at least one electron-drawing group; and
wherein R₃ is H, or an unsubstituted or a substituted C₁₋₁₀ alkyl group.

In a further aspect, the present disclosure provides a pre-treated product obtained by the process described herein.

In a further aspect, the present disclosure provides a product pre-treated by the acidic agent described herein.

In a further aspect, the present disclosure provides use of the acidic agent described herein in the pre-treatment of an odorous product, e.g., for reducing the amount of odorous species comprised in the product.

In a further aspect, the present disclosure provides a polyurethane composition, comprising,
(A) a polyol component comprising one or more polyols selected from the group consisting of a polyester polyol, a polyether polyol, and the combination thereof, and
(B) an isocyanate component comprising one or more isocyanate compounds,
wherein the polyol component (A) comprises a pre-treated polyether polyol and/or SPE surfactant product obtained by the process described herein.

In a further aspect, the present disclosure provides use of the pre-treated product described herein in the preparation of a polyurethane composition.

In a further aspect, the present disclosure provides a polyurethane product formed using the polyurethane composition described herein.

In a further aspect, the present disclosure provides use of the product described herein in the manufacture of a polyurethane product.

The formation of odorous species is reduced in the odorous product pre-treated according to the present disclosure, and thus in downstream (e.g., polyurethane) products produced therefrom. It is to be understood that both the foregoing general description and the following detailed description are exemplary and explanatory only and are not restrictive of the invention, as claimed.

### DETAILED DESCRIPTION OF THE DISCLOSURE

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

As disclosed herein, “and/or” means “and, or as an alternative”. All ranges include endpoints unless otherwise indicated.

As disclosed herein, all percentages mentioned herein are by weight, and temperatures in ° C., unless specified otherwise.

As used herein, “room temperature” refers to a temperature that is from 20° C. to 25° C., for example, 20° C., 21° C., 22° C., 23° C., 24° C., 25° C., or any range therebetween.

### A. Pre-Treatment of Odorous Products

A long root cause analysis has been carried out to examine the probable causes of the undesired odor issue in polyurethane systems. Two major sources of different cyclic ethers have been identified: silicone polyether (SPE) surfactants and polyether polyols with high unsaturation level.

“SPE surfactants” typically refer to silicone surfactants having siloxane backbones and polyether pendant groups. Typically, an SPE surfactant is formed by grafting a vinyl polyether onto a silicone backbone. During manufacturing of SPE surfactants, the vinyl polyether may be used in excess to ensure the completeness of the hydrosilylation reaction. The excess vinyls are vulnerable to continuously generate aldehydes, ethylene glycol (EG) or propylene glycol (PG) etc. during storage, especially upon part of acetaldehyde is oxidized to acetic acid. The H⁺ can greatly accelerate the degradation of unsaturation to form different aldehydes and diols. These aldehydes and diols can go through cyclization process to form different cyclic ethers.

Similarly, in polyols, there is some unsaturation due to side reactions during alkoxylation with propylene oxide.

The presence of these unsaturated species and aldehydes and other by products causes the formation of other species such as cyclic ethers, in particular of trioxocane. The content of trioxocane in polyol/surfactant increases significantly after accelerated aging, hence some increase is also to be expected during storage at room temperature. This can be troublesome, because both SPE surfactants and polyether polyols are materials widely used in polyurethane foam manufacture, and they can cause significant odor issues even when present at very low levels. For example, the trioxocane level in SPE surfactants can increase to as high as 26 ppm after aging at 80° C. for 16 hours under acidic condition. An SPE surfactant used in an amount as low as only around 1% in the full flex polyurethane formulation can still cause substantial odor issue in the final flex foams.

The present disclosure addresses the issue by pre-treatment of the products as described below.

In an aspect, the present disclosure provides a process of pre-treatment of an odorous product selected from the group consisting of a polyether polyol product, an SPE surfactant product and a combination thereof, comprising, adding an acidic agent with aldehyde abatement capability to the product, wherein the acidic agent has the structure of formula (1):

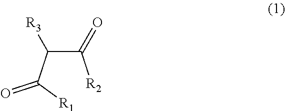

wherein R₁ and R₂ are individually selected from the group consisting of —OH, —NH, —NH₂, or a C₁₋₁₀ alkyl (e.g., a C₁-C₈, C₁-C₆, or C₁-C₄ alkyl) unsubstituted or substituted with at least one substituent selected from the group consisting of a halogen (e.g., F, Cl, Br, or I), —OH, —NH, —NH₂, —OSO₃H, —SO₃H, —COOH, —OPO(OH)₂, a C₁-C₆ alkyl (e.g., a C₁-C₄ alkyl), a C₁-C₆ alkoxy (e.g., a C₁-C₄ alkoxy), and a C₃-C₆ alicyclic or aromatic ring whose carbon atom(s) is optionally replaced with at least one hetero atom selected from the group consisting of N, O and S; or optionally, R₁ and R₂ are linked by a single bond or a divalent linker group to form a cyclic structure;
with the proviso that at least one of R₁ and R₂ comprises at least one proton-releasing group selected from the group consisting of —OH, —NH, —NH₂, —OSO₃H, —SO₃H, —COOH, and —OPO(OH)₂; and, when the at least one proton-releasing group is —NH or —NH₂, it is adjacent to at least one electron-drawing group; and
wherein R₃ is H, or an unsubstituted or a substituted C₁₋₁₀ alkyl group.

Generally, the “odorous product” used herein refers to a product where odorous by-products (such as cyclic ethers) are formed. Polyether polyol products and SPE surfactant products are found to be representative examples of such products.

In formula (1), at least one of R₁ and R₂ comprises a proton-releasing group. The proton-releasing group can be selected from the group consisting of —OH, —NH, —NH₂, —OSO₃H, —SO₃H, —COOH, and —OPO(OH)₂.

In some embodiments, at least one of R₁ and R₂ comprises an —NH or —NH₂ group that is adjacent to at least one electron-drawing group. In some embodiments, the N atom(s) can be unsubstituted or substituted by, for example, one or more substituents comprising but not limited to a cyano, a halogen (e.g., —F, —Cl, —Br, or —I), a C₁-C₄ alkyl (e.g., methyl, ethyl, propyl, butyl), and a C₆-C₁₂ aryl.

In some embodiments, R₁ and R₂ are linked by a single bond to form a cyclic structure.

In some embodiments, R₁ and R₂ are linked by a divalent linker group to form a cyclic structure. The divalent linker group can be selected from the group consisting of —C(O)—, —C(O)O—, —S(O)₂— and a C₁-C₄ alkylene (e.g., methylene, ethylidene, propylidene, butylidene). In some embodiments, the divalent linker is or comprises an electron withdrawing group.

Electron withdrawing groups are well known to a person skilled in the art of organic synthesis. Examples of electron withdrawing groups can comprise, but are not limited to, a halogen (e.g., —F, —Cl, —Br, or —I), a nitrile, a carbonyl group, a nitro group, a sulphamoyl group, a sulphonate group, a hydroxy group, or an amino group.

In formula (1), R₃ is H, or an unsubstituted or a substituted C₁₋₁₀ alkyl group. In some embodiments, R₃ is H. In some embodiments, R₃ is an unsubstituted or a substituted C₁₋₁₀ alkyl group, for example, an unsubstituted or a substituted C₁₋₈, C₁₋₆ or C₁₋₄ alkyl group. Suitable substituents can comprise, but are not limited to, a cyano, a halogen (e.g., —F, —Cl, —Br, or —I) and a C₁-C₄ alkyl (e.g., methyl, ethyl, propyl, butyl).

In some embodiments, the acidic agent can comprise or be selected from acidic nitrogen-containing compounds.

In some embodiments, the acidic agent can comprise or be selected from acidic cyclic ureide compounds.

In some embodiments, the acidic agent has a pKa of from 2.0 to 5.0. In some embodiments, the acidic agent has a pKa within the range obtained by combining any two of the following endpoints: 2.0, 2.5, 3.0, 3.5, 4.0, 4.5 and 5.0. In some embodiments, the acidic agent has a pKa of from 2.0 to 4.5, from 2.5 to 4.0, or from 3.0 to 4.0.

In some embodiments, the acidic agent has a molar weight of from 80 to 2000 g/mol. In some embodiments, the acidic agent has a molar weight within the range obtained by combining any two of the following endpoints: 80, 160, 240, 320, 400, 480, 560, 640, 720, 800, 960, 1,120, 1,280, 1,440, 1,600, 1,760, 1,920, 1,980, 1,990, and 2,000 g/mol. In some embodiments, the acidic agent has a molar weight of from 80 to 1280 g/mol, from 80 to 640 g/mol, or from 80 to 320 g/mol.

In an exemplary embodiment, the acid agent comprises barbituric acid (CAS 67-52-7) and its derivatives. Barbituric acid (pyrimidine-2,4,6(1H,3H,5H)-trione) is of the following structure:

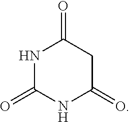

Exemplary derivatives of barbituric acid can comprise, but are not limited to,

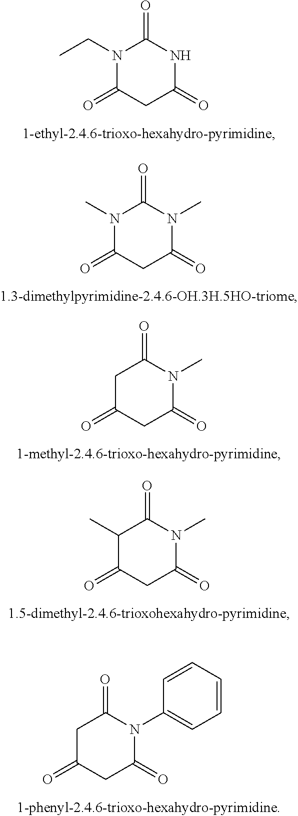

The acidic agent according to the present disclosure combines acidity and aldehyde abatement capability. In other words, the acidic agent can work as both an acid to degrade the unsaturation and an aldehyde abatement agent to scavenge the aldehydes and thus suppress the formation of cyclic ethers.

The acidic agent is for pre-treatment of an odorous product.

As used herein, “pre-treating” or “pre-treatment” of an odorous (e.g., a polyether polyol and/or SPE surfactant) product refers to the application of the acidic agent described herein to the product prior to being used as raw materials in downstream applications (for example, the preparation of polyurethane compositions or polyurethane products). In other words, the removal of odorous species occurs before the product is used in downstream applications.

In some embodiments, the acidic agent is added to the odorous product before it is used as a raw material in formulation of polyurethane compositions or polyurethane products.

In some embodiments, the pre-treating of the odorous product with the acidic agent described herein is carried out after the product is synthesized or produced. In some embodiments, the acidic agent is added to the odorous product after the synthesis or preparation of the product is completed. One or more acidic agent (if any) used for the synthesis or preparation of the odorous product are not sufficient to be considered as the pre-treating or pre-treatment described herein. In some embodiments, the pre-treating is carried out after the synthesis or preparation of the product is completed and before it is packaged or stored.

Typically, the pre-treatment is carried out by combining (e.g., mixing) the odorous product with the acidic agent.

In exemplary embodiments, the acidic agent is used alone as an active agent (not counting solvents or diluents such as water) for the pre-treatment, not in combination with one or more other active agents (e.g., an amine). In exemplary embodiments, the acidic agent is used in the pre-treatment not in combination with another active agent such as an amine.

In some embodiments, the pre-treatment lasts for at least 6 hours, for example, at least 8, at least 10, at least 12, or at least 24 hours.

In some embodiments, the amount of the acidic agent added to the odorous product is from 0.01% to 1.00% by weight of the odorous product. In some embodiments, the amount of the acidic agent added to the odorous product is within the range obtained by combining any two of the following endpoints: 0.05%, 0.10%, 0.15%, 0.20%, 0.25%, 0.30%, 0.35%, 0.40%, 0.45%, 0.50%, 0.55%, 0.60%, 0.65%, 0.70%, 0.75%, 0.80/o, 0.85%, 0.90%, 0.95%, and 1.00%, by weight of the odorous product. In some embodiments, the amount of the acidic agent added to the odorous product is from 0.05% to 0.90%, from 0.08 to 0.80%, from 0.10% to 0.70% or from 0.20% to 0.60%, by weight of the odorous product.

The SPE surfactants can be nonhydrolyzable or hydrolyzable. The nonhydrolyzable surfactants, in which the polyether pendant groups are attached to the siloxane backbone by Si—C bonds, are generally believed to have high potency but produce “tight” polyurethane foams with poor breathability. Hydrolyzable surfactants, in which the polyether pendant groups are attached to the siloxane backbone by Si-bonds, are generally believed to have less potency but offer good processing characteristics, and produce polyurethane foams with good breathability.

Typically, an SPE surfactant is formed by grafting a vinyl polyether onto a silicone backbone. In some embodiments, the SPE surfactants can be obtained by the reaction of a hydrogen siloxane (for example, an organohydrogensiloxane) and a polyether compound having an aliphatically unsaturated group, in the presence of a hydrosilylation catalyst. The methods for preparing SPE surfactants are known in the art and can be found in vast literature, for example, EP1081182B1, which is incorporated herein by reference in its entirety.

Polyols that can be pre-treated according to the present disclosure can comprise, but are not limited to, di-, tri-, tetra-, poly-functional polyether polyol obtained by reaction of an initiator with alkylene oxide, e.g., ethylene oxide (EO), propylene oxide (PO), and combinations thereof. In particular, polyols that may be suitable for the pre-treatment according to the present disclosure are those polyether polyols with high equivalent weight and with high PO content (PO content >50%) as this type of polyols may contain a certain amount of unsaturation which may lead to odorous species in the final polyurethane polymer. The pre-treatment removes the unsaturation and prevents the formation of the odorous species.

In some embodiments, the hydroxyl equivalent weight of the polyether polyols to be pre-treated according to the present disclosure can be, for example, at least 800, at least 900, at least 1000, at least 1200 or at least 1500, and can be, for example, up to 3000, up to 2500 or up to 2000. Equivalent weight is conveniently determined using titration methods per ASTM 4274-88 or equivalent, converting the measured hydroxyl number in mg KOH/g to equivalent weight using the relationship: Equivalent Weight=56,100÷hydroxyl number. The molecular weight of the polyether polyols to be pre-treated according to the present disclosure can be, for example, at least 300, at least 1000, at least 2500, at least 5000, at least 6000, at least 8000 or at least 11,000 g/mol and, for example, up to 25,000, up to 15,000 or up to 14,000 g/mol. Molecular weights as reported herein are number averages as determined using gel permeation chromatography methods, against a polystyrene standard.

In some embodiments, the polyether polyols to be pre-treated according to the present disclosure can have a PO content of greater than 50%, greater than 60%, greater than 70%, or greater than 80%.

It is surprisingly found that the pre-treatment of the odorous product with the acidic agent described herein can degrade the unsaturation of the product, abate the aldehydes and even degrade the formed cyclic ethers. This can remove the root cause of the formation of odorants (e.g., cyclic ethers) as by-products, and facilitate great reduction in odorant level in final polyurethane foams.

### B. Pre-Treated Products

In a further aspect, the present disclosure provides a pre-treated product obtained by the process described herein.

The “pre-treated product” as used herein refers to a product (e.g., a polyether polyol product and/or an SPE surfactant product) that is pre-treated with the acidic agent described herein.

Generally, the product before the pre-treatment is an odorous product.

In some embodiments, the acidic agent is mixed with the odorous product after the synthesis or preparation of the product is completed.

In some embodiments, the product is pre-treated before storage.

In some embodiments, the amount of the acidic agent comprised in the pre-treated product is from 0.01% to 1.00%, by weight of the product. In some embodiments, the amount of the acidic agent comprised in the pre-treated product is within the range obtained by combining any two of the following endpoints: 0.01%, 0.05%, 0.10%, 0.15%, 0.20%, 0.25%, 0.30%, 0.35%, 0.40%, 0.45%, 0.50%, 0.55%, 0.60%, 0.65%, 0.70%, 0.75%, 0.80%, 0.85%, 0.90%, 0.95%, and 1.00%, by weight of the product. In some embodiments, the amount of the acidic agent comprised in the pre-treated product is from 0.05% to 0.90%, from 0.08 to 0.80%, from 0.10% to 0.70% or from 0.20% to 0.60%, by weight of the product.

In some embodiments, the amount of odorous species generated from the pre-treated product is lower (for example, 30%, 40%, 50%, 60%, 70%, 80%, 90%, or 95% or more lower) than that of the same product except that it is not pre-treated according to the present disclosure, even after a duration of storage as short as about 24 hours at room temperature. The longer the storage, the more evident the reduction in the amount of odorous species is in the product pre-treated according to the present disclosure. Examples of the odorous species can be one or more selected from the group consisting of aldehydes, cyclic ethers (e.g., trioxocane, EMD, DMD), and any combination thereof.

In a further aspect, the present disclosure provides a product pre-treated by the acidic agent described herein.

For conciseness, the (odorous) product and the acidic agent are as described in the “A. Pre-treatment of odorous products” portion above.

### C. Polyurethane Composition

In a further aspect, the present disclosure provides a polyurethane composition, comprising,
(A) a polyol component comprising one or more polyols selected from the group consisting of a polyester polyol, a polyether polyol, and the combination thereof, and
(B) an isocyanate component comprising one or more isocyanate compounds,
wherein the polyol component (A) comprises the pre-treated product (e.g., polyether polyol and/or SPE surfactant product) obtained by the process described herein.

The polyurethane composition according to the present disclosure is a two-component composition comprising (A) a polyol component and (B) an isocyanate component. In some embodiments, the polyurethane composition is a polyurethane foam composition.

As used herein, the term “two-component” means that the polyurethane foam composition is provided in parts separated from each other before use. Typically, the composition according to the present disclosure can comprise at least a first component comprising one or more polyols selected from the group consisting of a polyester polyol, a polyether polyol, and the combination thereof (also referred to herein as a “polyol component”, “polyol component (A)”, or “OH component”), and a second component comprising one or more isocyanate compounds (also referred to herein as an “isocyanate component”, “isocyanate component (B)”, or “NCO component”). The polyol component and the isocyanate component can be prepared, stored, transported and served separately, and combined shortly or immediately before being applied to, for example, products to be potted. It is contemplated that when these two components are brought into contact, a curing reaction begins in which the polyol groups react with the isocyanate groups to form urethane links. The reactive polyurethane dispersion formed by bringing the two components into contact can be referred to as a “reaction mixture” or a “curable mixture.”

In some embodiments, the NCO/OH ratio of the isocyanate component to the polyol component comprised in the polyurethane foam composition can be within the range of from 0.8:1 to 1.2:1. In some embodiments, NCO/OH ratio of the isocyanate component to the polyol component can be within the range obtained by combining any two of the following endpoints: 0.8:1, 0.9:1, 1:1, 1.1:1, 1.2:1. In some specific embodiments, the NCO/OH ratio of the isocyanate component to the polyol component can be within the range of from 0.8:1 to 1.2:1, from 0.8:1 to 1.1:1, from 0.8:1 to 1:1, from 0.9:1 to 1.2:1, from 0.9:1 to 1.1:1, from 0.9:1 to 1:1 or from 1:1 to 1:1.1.

As used herein, the term “NCO/OH ratio” refers to the ratio of the number of isocyanate groups to the number of hydroxyl groups in the polyurethane foam composition; or more specifically, the ratio between the number of isocyanate groups in the isocyanate component and the number of hydroxyl groups in the polyol component, of the polyurethane composition.

In some embodiments, the polyurethane composition further comprises one or more catalysts, including amine compounds (for example, tertiary amine compounds), organometallic compounds, and any combination thereof. Exemplary tertiary amine compounds can comprise, but are not limited to, triethylenediamine, N-methylmorpholine, N,N-dimethylcyclohexylamine, N,N′,N′-dimethylaminopropylhexahydrotriazine, 2-hydroxy-N,N,N-trimethylpropan-1-aminium formate, pentamethyldiethylenetriamine, tetramethylethylenediamine, 1-methyl-4-dimethylaminoethylpiperazine, 3-methoxy-N-dimethylpropylamine, N-ethylmorpholine, diethylethanolamine, N-cocomorpholine, N,N-dimethyl-N′,N′-dimethyl isopropylpropylenediamine, N,N-diethyl-3-diethylaminopropylamine and dimethylbenzylamine. Exemplary organometallic catalysts can comprise, but are not limited to, organomercury, organolead, organoferric and organotin catalysts. Suitable tin catalysts can comprise, but are not limited to, stannous chloride, tin salts of carboxylic acids such as dibutyltin di-laurate, as well as other organometallic compounds such as are disclosed in U.S. Pat. No. 2,846,408. A catalyst for the trimerization of polyisocyanates, resulting in a polyisocyanurate, such as an alkali metal alkoxide may also optionally be employed herein. Such catalysts are used in an amount which measurably increases the rate of polyurethane formation. The one or more catalysts can be comprised in either or both of the polyol component and the isocyanate component. Typical amounts are 0.001 to 3 parts by weight of catalyst per 100 parts by weight the polyol component. In some embodiments, the polyurethane composition comprises amine catalysts, tin catalysts, or a mixture thereof.

In some embodiments, the polyurethane composition further comprises one or more blowing agents. The blowing agent used in the polyurethane composition can comprise at least one physical blowing agent which is selected from a hydrocarbon, hydrofluorocarbon, hydrochlorofluorocarbon, fluorocarbon, dialkyl ether or fluorine-substituted dialkyl ether, or any combination thereof. Blowing agents of these types can comprise, but are not limited to, propane, isopentane, n-pentane, n-butane, isobutane, isobutene, cyclo-pentane, dimethyl ether, 1,1-dichloro-1-fluoroethane (HCFC-141b), chlorodifluoromethane (HCFC-22), 1-chloro-1,1-difluoroethane (HCFC-142b), 1,1,1,2-tetrafluoroethane (HFC-134a), 1,1,1,3,3-pentafluorobutane (HFC-365mfc), 1,1-difluoroethane (HFC-152a), 1,1,1,2,3,3,3-heptafluoropropane (HFC-227ea), 1,1,1,3,3-pentafluoropropane (HFC-245fa), hydrofluoroolefin (HCFO), hydrofluoroolefin (HFO) such as LBA, and any combination thereof. The polyurethane composition can also comprise a chemical blowing agent, such as water, carboxylic acid, formic acid, and any combination thereof. The one or more blowing agents can be comprised in either or both of the polyol component and the isocyanate component. In some embodiments, the one or more blowing agents are comprised in the polyol component. Typically, the blowing agent constitutes from 1 to 20 parts by weight per 100 parts by weight the polyol component.

Optionally, the polyurethane composition further comprises one or more chain extension and or cross linkage materials. Examples of such materials can comprise, but are not limited to, ethylene glycol, diethylene glycol, triethylene glycol, propylene oxide, propylene glycol, dipropylene glycol, tripropylene glycol, 1,4-butane diol, 1,6-hexane diol, 1,8-octane diol, cyclohexane dimethanol, glycerin, trimethylolpropane, trimethylolethane, pentaerythritol, sorbitol and sucrose, as well as alkoxylates, diethanol amine, monoethanol amine, triethanol amine, mono-, di- or tri(isopropanol) amine, glycerine, trimethylol propane, and combinations thereof.

Optionally, the polyurethane composition further comprises crosslinking materials and one or more additives such as fillers, anti-oxidants, preservatives, pigments, colorants, and flame retardant additives.

In some embodiments, the amount of odorous species generated from the polyurethane composition comprising the product subjected to the pre-treatment according to the present disclosure is lower (for example, 30%, 40%, 50%, 60%, 70%, 80%, 90%, or 95% or more lower) than that of the polyurethane composition comprising the same polyether polyol and/or SPE surfactant product without the pre-treatment, even after a duration of storage as short as about 24 hours at room temperature. The longer the storage, the more evident the reduction in the amount of odorous species is in the polyurethane composition comprising the product pre-treated according to the present disclosure. The odorous species can be one or more selected from aldehydes, cyclic ethers (e.g., trioxocane, EMD, DMD), or a mixture thereof.

### (A) The Polyol Component

The polyol component comprised in the polyurethane composition comprises the product (e.g., polyether polyol and/or SPE surfactant product) pre-treated according to the present disclosure.

The polyol component comprised in the polyurethane composition comprises one or more polyols. The one or more polyols comprised in the polyurethane composition can be selected from the group consisting of polyester polyols, polyether polyols, and any combination thereof.

As used herein, the term “polyol” refers to a compound with two or more hydroxyl groups. A polyol is a “diol” when it has exactly two hydroxyl groups, a “triol” when it has exactly three hydroxyl groups, a “tetraol” when it has exactly four hydroxyl groups, a “pentanol” when it has exactly five hydroxyl groups, and so on.

In some embodiments, the one or more polyols in the polyol component have an average hydroxyl group functionality of from 2 to 8, for example, from 2 to 7, or from 3 to 6.

In some embodiments, the one or more polyols in the polyol component have an average hydroxyl group number from 25 to 1000 mg KOH/g, for example, from 25 to 900 mg KOH/g, from 28 to 1000 mg KOH/g, or from 28 to 900 mg KOH/g.

In some embodiments, the polyol component can comprise a polyester polyol. A compound that contains two or more ester linkages in the same linear chain of atoms is known herein as a “polyester.” A compound that is both a polyester and a polyol is known herein as a “polyester polyol.”

The polyester polyols employed in the polyurethane composition can have a molecular weight not to exceed 14,000 g/mol.

In some embodiments, the polyester polyols can have a hydroxyl group functionality of at least 2 (i.e., ƒ≥2). In some embodiments, the polyester polyols can have a hydroxyl group functionality of not to exceed 10 (i.e., ƒ≤10). In some embodiments, the polyester polyols can have a hydroxyl group functionality within the range of from 2 to 8, from 2 to 7, from 3 to 7, from 3 to 6, or from 3 to 5.

In some embodiments, the polyester polyols can have a hydroxyl group number of greater than 25 mg KOH/g. In some embodiments, the polyester polyols can have a hydroxyl group number of smaller than 1,000 mg KOH/g. In some embodiments, the polyester polyols can have an average hydroxyl group number of from 25 to 950 mg KOH/g, from 25 to 900 mg KOH/g, from 27 to 1000 mg KOH/g, from 27 to 950 mg KOH/g, from 28 to 1000 mg KOH/g, or from 28 to 950 mg KOH/g.

In some embodiments, the polyester polyols can comprise, but are not limited to, polycondensates of diols and also, optionally, polyols (e.g., triols, tetraols), and of dicarboxylic acids and also, optionally, polycarboxylic acids (e.g., tricarboxylic acids, tetracarboxylic acids) or hydroxycarboxylic acids or lactones. The polyester polyols can also be derived from, instead of the free polycarboxylic acids, the corresponding polycarboxylic anhydrides, or corresponding polycarboxylic esters of lower alcohols.

Suitable diols can comprise, but are not limited to, ethylene glycol, butylene glycol, diethylene glycol, triethylene glycol, pentylene glycol, hexalene glycol, polyalkylene glycols, such as polyethylene glycol, and also 1,2-propanediol, 1,3-propanediol, 1,3-butanediol, 1,4-butanediol, 1, 6-hexanediol, and neopentyl glycol. If a polyester polyol functionality greater than 2 is to be achieved, polyols having a functionality of 3 or greater can optionally be comprised in the polyol composition (e.g., trimethylolpropane, glycerol, erythritol, pentaerythritol, trimethylolbenzene or trishydroxyethyl isocyanurate).

Suitable dicarboxylic acids can comprise, but are not limited to, aliphatic acids, aromatic acids, and combinations thereof. Examples of suitable aromatic acids can comprise, but are not limited to, phthalic acid, isophthalic acid, terephthalic acid, and tetrahydrophthalic acid. Examples of suitable aliphatic acids can comprise, but are not limited to, hexahydrophthalic acid, cyclohexane dicarboxylic acid, adipic acid, azelaic acid, sebacic acid, glutaric acid, tetrachlorophthalic acid, maleic acid, fumaric acid, itaconic acid, malonic acid, suberic acid, 2-methyl succinic acid, 3,3-diethyl glutaric acid, 2,2-dimethyl succinic acid, and trimellitic acid. As used herein, the term “acid” also comprises any anhydrides of said acid. Further, monocarboxylic acids, such as benzoic acid and hexane carboxylic acid, should be minimized or excluded from the disclosed compositions. Saturated aliphatic and/or aromatic acids are also suitable for use according to this disclosure, such as adipic acid or isophthalic acid.

In some embodiments the polyol component can comprise a polyether polyol.

A compound that contains two or more ether linkages in the same linear chain of atoms is known herein as a “polyether.” A compound that is a polyether and a polyol is a “polyether polyol.”

The polyether polyols employed in the polyurethane composition can have a molecular weight not to exceed 10,000 g/mol.

In some embodiments, the polyether polyols can have a hydroxyl group functionality of at least 2 (i.e., ƒ≥2). In some embodiments, the polyether polyols can have a hydroxyl group functionality of not to exceed 10 (i.e., ƒ≤10). In some embodiments, the polyether polyols can have a hydroxyl group functionality within the range of from 2 to 8, from 2 to 7, from 3 to 7, from 3 to 6, from 3 to 5.

In some embodiments, the polyether polyols can have a hydroxyl group number of greater than 25 mg KOH/g. In some embodiments, the polyether polyols can have a hydroxyl group number of smaller than 1,000 mg KOH/g. In some embodiments, the polyether polyols can have an average hydroxyl group number of from 25 to 950 mg KOH/g, from 25 to 900 mg KOH/g, from 27 to 1000 mg KOH/g, from 27 to 950 mg KOH/g, from 28 to 1000 mg KOH/g, or from 28 to 950 mg KOH/g.

In some embodiments, the polyether polyols for use in the present disclosure are obtained by the addition polymerisation of alkylene oxides with initiators, such as polyhydric alcohol starter compounds. Examples of such polyhydric alcohols can comprise, but are not limited to, glycerin, sorbitol, sucrose, glucose, fructose, lactose or other sugars. In some embodiments, the starter compound is sorbitol or sucrose. These polyhydric alcohols as well as mixtures of these alcohols with water, glycerol, propylene glycol, ethylene glycol or diethylene glycol, may be used as starter compounds. Examples of suitable sorbitol- or sucrose/glycerine-initiated polyethers that can be used can comprise, but are not limited to, VORANOL™ 446, VORANOL™ 520, VORANOL™ 550, VORANOL™ RN 482, VORANOL™ CP 6001, VORANOL™ CP 4711 polyols, all available from The Dow Chemical Company.

In some embodiments, the polyol component can have a viscosity at 25° C. of from 200 cSt to 38,000 cSt, for example, from 200 cSt to 35,000 cSt, or from 250 cSt to 35,000 cSt, as measured according to ASTM D2196.

### (B) The Isocyanate Component

The isocyanate component comprised in the polyurethane composition comprises one or more isocyanate compounds reactive with the one or more polyols in the polyol component.

In some embodiments, the isocyanate component can comprise the SPE surfactant pre-treated according to the present disclosure.

In some embodiments, the isocyanate compound can be one or more selected from isocyanate monomers, isocyanate prepolymers, modified isocyanates and combination thereof.

As used herein, an “isocyanate monomer” is any compound that contains two or more isocyanate groups. An “aromatic isocyanate” is an isocyanate that contains one or more aromatic rings. An “aliphatic isocyanate” contains no aromatic rings. In some embodiments, the isocyanate compound comprises an aromatic isocyanate.

Isocyanate monomers suitable for use according to the disclosure can be selected from the group consisting of aromatic isocyanates, aliphatic isocyanates, carbodiimide modified isocyanates, and the combinations thereof. Examples of aromatic isocyanates suitable for use according to the disclosure can comprise, but are not limited to, isomers of methylene diphenyl dipolyisocyanate (“MDI”) such as 4,4-MDI, 2,4-MDI and 2,2′-MDI, or modified MDI such as carbodiimide modified MDI or urethane modified MDI or allophanate modified MDI; isomers of toluene-dipolyisocyanate (“TDI”) such as 2,4-TDI, 2,6-TDI, isomers of naphthalene-dipolyisocyanate (“NDI”) such as 1,5-NDI, and the combinations thereof. Examples of aliphatic isocyanates suitable for use according to this disclosure can comprise, but are not limited to, isomers of hexamethylene dipolyisocyanate (“HDI”), isomers of isophorone dipolyisocyanate (“IPDI”), isomers of xylene dipolyisocyanate (“XDI”), isomers of methylene-bis-(4-cyclohexylisocyanate) (“HMDI”), and the combinations thereof. In some embodiments, the isocyanate monomers comprises diisocyanate monomers selected from the group consisting of isophorone diisocyanate (IPDI), methylene-bis-(4-cyclohexylisocyanate) (HMDI), hexamethylene diisocyanate (HDI), methylene diphenyl diisocyanate (MDI), toluene diisocyanate (TDI), and the combination thereof.

In some embodiments, the isocyanate component of the polyurethane composition can be prepared using any organic polyisocyanates, modified polyisocyanates, isocyanate based prepolymers, and mixtures thereof. These can comprise aliphatic and cycloaliphatic isocyanates, but aromatic and especially multifunctional aromatic isocyanates such as 2,4- and 2,6-toluenediisocyanate and the corresponding isomeric mixtures; 4,4′-, 2,4′- and 2,2′-diphenyl-methanediisocyanate (MDI) and the corresponding isomeric mixtures; mixtures of 4,4′-, 2,4′- and 2,2′-diphenylmethanediisocyanates and polyphenyl polymethylene polyisocyanates (PMDI); and mixtures of PMDI and toluene diisocyanates are preferred. Most preferably, the polyisocyanate used to prepare the formulation of the present invention is MDI or PMDI or crude mixtures of any of these.

In some embodiments, the isocyanate component can have a viscosity at 25° C. of from 50 mPa·s to 20,000 mPa·s, from 50 mPa·s to 18,000 mPa·s, or from 100 mPa·s to 18,000 mPa·s, as measured according to ASTM D2196.

### D. Polyurethane Product

In a further aspect, the present disclosure provides a polyurethane product formed using the polyurethane composition comprising the pre-treated product described above.

In some embodiments, the polyurethane product is polyurethane foam.

In some embodiments, the polyurethane foam formed using the pre-treated product has a foam density of lower than 800 kg/m³.

Generally, the polyurethane foam can be formed by (i) providing the polyurethane composition comprising (A) a polyol component and (B) an isocyanate component as described; (ii) forming a reaction mixture by mixing the polyol component (A) with the isocyanate component (B); (iii) subjecting the reaction mixture to conditions such that reacts, expands, and cures to form a polyurethane foam.

The polyol component (A) and the isocyanate component (B) are as described in the “C. Polyurethane composition” portion above.

In some embodiments, the reaction mixture reacts, expands and cures within an enclosed space to form polyurethane foam within said enclosed space. In some embodiments, the reaction mixture is allowed to react, expand and cure at room temperature or higher.

In some embodiments, the amount of odorous species generated from the polyurethane product manufactured according to the present disclosure (i.e., using the pre-treated product) is lower (for example, 30%, 40%, 50%, 60%, 70%, 80%, 90%, or 95% or more lower) than that of the polyurethane product manufactured using the same polyurethane composition comprising the same product without the pre-treatment according to the present disclosure, even after a duration of storage as short as about 24 hours at room temperature. The longer the storage, the more evident the reduction in the amount of odorous species is in the polyurethane product comprising the product pre-treated according to the present disclosure. The odorous species can be one or more selected from aldehydes, cyclic ethers (e.g., trioxocane, EMD, DMD), or a mixture thereof.

### E. Applications and Advantages

In a further aspect, the present disclosure provides use of the acidic agent described herein in the pre-treatment of an odorous product, e.g., for reducing the amount of odorous species comprised in the product.

In a further aspect, the present disclosure provides use of the pre-treated polyether polyol and/or SPE surfactant product in the preparation of a polyurethane composition.

In some embodiments, the polyurethane composition is a polyurethane foam composition.

In a further aspect, the present disclosure provides use of the pre-treated polyether polyol and/or SPE surfactant product described herein in the manufacture of a polyurethane product.

In some embodiments, the polyurethane product is polyurethane foam.

In the present disclosure, a process of pre-treatment of an odorous product is provided to degrade the unsaturation in the product, suppress the cyclization of aldehydes and diols by abating the aldehydes, and degrade those formed cyclic ethers, so that the level of odorous species formed in the product is substantially reduced.

The advantages provided by the present disclosure can include:
(1) The pre-treatment is implemented by using an additive, which is added to the odorous product in a simple step;
(2) The pre-treatment facilitates to degrade the unsaturation in advance and thus eliminate the forming of cyclic ethers afterwards;
(3) The additive can abate the aldehydes after degradation of unsaturation, and can also degrade the formed cyclic ethers through a ring opening process, so that the level of odorous species is substantially reduced.

### EXAMPLES

Some embodiments of the invention will now be described in the following Examples, wherein all parts and percentages are by weight unless otherwise specified.

Reagent and Chemicals

| Ingredient Type | Chemical Description, Chemical formula, or Structure | Source |
|---|---|---|
| Polyol 1 | A diol polyether polyol, PO based and EO capped, 4000 | The Dow Chemical |
| | molecular weight | Company |
| Polyol 2 | A triol polyether polyol, PO based and EO capped, 6000 | The Dow Chemical |
| | molecular weight. | Company |
| Polyol 3 | A triol polyether polyol, PO based and EO capped, 5000 | The Dow Chemical |
| | molecular weight. | Company |
| Polyol 4 | Triol obtained by alkoxylation of glycerine with mixfeed | The Dow Chemical |
| | PO/EO, 3000 molecular weight | Company |
| Isocyanate 1 | Toluene diisocyanate, 80:20 isomeric ratio of 2,4-TDI | The Dow Chemical |
| | and 2,6-TDI | Company |
| Catalyst T-9 | Tin(II) 2-ethylhexanoate | Sinopharm Chemical |
| | | Reagent Co., Ltd |
| JEFFCAT ™ ZR-50 | 1-(bis(3-(dimethylamino)propyl)amino)propan-2-ol | Huntsman |
| Phosphoric acid | Phosphoric acid >98% | Sinopharm Chemical |
| | | ReagentCo., Ltd |
| Barbituric acid | Barbituric acid >98% | Sinopharm Chemical |
| | | ReagentCo., Ltd |
| NIAX ™ Silicone | A SPE surfactant of medium potency, suggested in the | Momentive |
| L-650 | production of flexible slabstock PU foam products | |
| TEGOSTAB ™ B8738 | Phthalate-free and low fogging type silicone surfactant. | Evonik |
| LF2 | | |
| VORASURF ™ TF | Low odor type high breathability silicone surfactant for | The Dow Chemical |
| 1365 | flex foam application. | Company |
| VORASURF ™ DC | Silicone surfactant for high resilience (HR) flexible | The Dow Chemical |
| 6070 | polyurethane slabstock foam. | Company |
| NIAX ™ L-580 | Non-hydrolyzable silicone surfactant | Momentive |
| NIAX ™ L-618 | Silicone surfactant for conventional flexible foams. | Momentive |
| PEI (Mw 600) | POLYETHYLENEIMINE | BASF |
| HPA-X | Heavy Polyamine X, a complex mixture of linear, | The Dow Chemical |
| | branched, and cyclic ethyleneamines | Company |
| MEA | Monoethanolamine | The Dow Chemical |
| | | Company |

### Sample Preparation

2.1 Polyol preparation: the detailed formulations are described for particular examples.
a. The additives, which were described as above, were firstly mixed with SPE surfactant and/or polyols based on the formulations in examples table below (see below formulations for each result).
b. The mixture of surfactant or polyols with additives was stored at room temperature overnight.
c. The above mixture was added with the other components and then mixed by a stirrer for 3 minutes at a speed of 3000 RPM to get formulated polyols as part A. Then the formulated polyols were stored at room temperature for 12-24 h before foaming.

2.2 Foaming procedure: An aliquot of 106.69 g formulated polyol was mixed with 58.4 g of TDI isocyanate to prepare the foam sample. After foaming, the foam sample was packaged with aluminum foil before analysis. The gas bag analysis was conducted within 7 days after foam sample was prepared.

### Quantification of Odorants in SPE Surfactants and Foam

3.1 Sample preparation: The samples (0.3 g) were put into a 20 mL headspace GC-MS vial for analysis.

3.2 SPME (solid phase micro-extraction) GC-MS method

### Example 1: Pre-Treatment of SPE Surfactants/Polyols with Different Additives

Table 1 shows the results in terms of remaining trioxocane levels for the SPE surfactant (Niax L650, 1.6 parts) untreated (CE-1) or treated with various agents including water (CE-2), an amine compound (PEI) in combination with water (CE-4), PEI and phosphoric acid in combination with water (CE-3), and barbituric acid in combination with water (IE-1).

The comparative examples with the amine (CE-3 and CE-4) were prepared and tested to evaluate the use of amines as aldehyde scavengers, as reported in the prior art.

These comparative examples showed a performance that is similar or worse compared with the reference sample (Example CE-1).

By contrast, the inventive example IE-1 showed already after 24 hours storage at room temperature a substantially lower content of trioxocane, which was further reduced after an additional 16 hours at 80 deg C.

TABLE 1
Application of different additives in SPE Niax L650

| | | CE-1 | CE-2 | CE-3 | CE-4 | IE-1 |
|---|---|---|---|---|---|---|
| Niax ™ L650 | pbw | 1.6 | 1.6 | 1.6 | 1.6 | 1.6 |
| H₂O | pbw | | 0.16 | 0.16 | 0.16 | 0.16 |
| Barbituric acid | pbw | | | | | 0.08 |
| PEI | pbw | | | 0.08 | 0.08 | |
| Phosphoric acid | pbw | | | 0.08 | | |
| Odorant remaining after storage at room | Trioxocane | 100.0 | 100.0 | 626.1 | 167.6 | 27.1 |
| temperature for 24 hour | | | | | | |
| Odorant remaining after additional | Trioxocane | 100.0 | 100.0 | 181.4 | 40.3 | 11.1 |
| storage at 80 degC for 16 hours | | | | | | |

Trioxocane units in the table are normalized to the reference CE-1 which is set to 100, thus higher values indicate that the amount of trioxocane is increasing, while lower values indicate that it is decreasing.

Then, the pre-treatment was applied to various polyol/surfactant samples:

Table 2 shows the impact of 0.48 wt % barbituric acid (BA) which was added to the polyol or SPE samples as follows:
BA was dissolved in 80 deg C. hot water to prepare a 4.77% BA aqueous solution;
10% of BA aqueous solution (4.77%) was added in Polyol or SPE samples shown in the table below, and mixed at R.T.: the samples were then tested after ageing at 80 deg C. for 16 hours;
10% of pure water was also added into same polyol or SPE sample as comparative samples.

In all cases the inventive samples, namely the samples that are pre-treated with a water solution containing barbituric acid, showed, after ageing, a substantially lower DMD, EMD and trioxocane content, when compared with the corresponding comparative samples, namely the samples that are treated with only water.

TABLE 2
Application of BA in various polyol and SPEs

| | | Amount of remained odorants | | |
|---|---|---|---|---|
| | | (Results for the comparative samples are set to 100 for normalization) | | |
| Materials | Examples | DMD | EMD | Trioxocane |
| Polyol 1 | CE-5 (w/o BA) | 100 | 100 | 100 |
| | IE-2 (w/ BA) | 55.8 | 32.0 | 32.0 |
| Polyol 2 | CE-6 (w/o BA) | 100 | 100 | 100 |
| | IE-3 (w/ BA) | 49.0 | 39.6 | 20.6 |
| Polyol 3 | CE-7 (w/o BA) | 100 | 100 | 100 |
| | IE-4 (w/ BA) | 45.2 | 25.7 | 28.5 |
| TEGOSTAB | CE-8 (w/o BA) | 100 | 100 | 100 |
| B8738 LF2 | IE-5 (w/ BA) | 49.4 | 57.6 | 20.1 |
| VORASURF ™ | CE-9 (w/o BA) | 100 | 100 | 100 |
| TF 1365 | IE-6 (w/ BA) | 52.6 | 54.5 | 26.9 |
| VORASURF ™ | CE-10 (w/o BA) | 100 | 100 | 100 |
| DC 6070 | IE-7 (w/ BA) | 65.0 | 89.6 | 29.6 |
| NIAX ™ L-580 | CE11 (w/o BA) | 100 | 100 | 100 |
| | IE-8 (w/ BA) | 55.2 | 65.3 | 70.8 |
| NIAX ™ L-618 | CE-12 (w/o BA) | 100 | 100 | 100 |
| | IE-9 (w/ BA) | 56.8 | 83.2 | 94.5 |

Values in the table are normalized to the reference (CE examples runs without barbituric acid) which is set to 100, thus higher values indicate that the amount of odorous by-products is increasing, while lower values indicate that it is decreasing.

### Example 2: Application of Pre-Treated SPE Surfactants in Foam Formulations

Foam formulations are as below. The foam was prepared comparing untreated Niax™ L650 with Niax™ L650 that was pre-treated with barbituric acid. The results show that the pre-treated Niax™ L650 results in a flex PU foam that has a substantially lower content of trioxocane.

TABLE 3
Foam preparations using untreated Niax ™
L650 vs pre-treated Niax ™ L650

| | CE 13 | IE 10 | IE 11 |
|---|---|---|---|
| Polyol 4 | 100 | 100 | 100 |
| H₂O | 4.6 | 4.6 | 4.6 |
| NIAX ™ L650 | 1.6 | | |
| NIAX ™ L650, 1.6 part, pre-treated | | 1.6 | |
| with 0.08 parts of BA, and aged for | | | |
| 16 hours at 80 deg C. | | | |
| NIAX ™ L650, 1.6 parts, pre-treated | | | 1.6 |
| with 0.04 parts of BA, and aged for | | | |
| 16 hours at 80 deg C. | | | |
| JEFFCAT ™ ZR50 | 0.21 | 0.21 | 0.21 |
| Catalyst T9 | 0.28 | 0.28 | 0.28 |
| Isocyanate 1 | 58.4 | 58.4 | 58.4 |
| Trioxocane amount in the PU foam | 100.0 | 3.2 | 3.5 |

Data in Table 4 were generated as follows.

CE-14: a simple mix of SPE surfactant and water and polyol and catalysts was prepared: the trioxocane content in the formulated polyol was tested immediately after. This is a reference sample, representing the case where the formulated polyol is prepared without pre-treatment of the surfactant.

IE-12: the surfactant was first pre-treated with BA in a water solution, and then the pre-treated surfactant was added to other formulated polyol ingredients (polyol, catalysts, and the remaining amount of water): the trioxocane content in the formulated polyol was tested immediately after. The amount of trioxocane in the resulting formulated polyol was strongly reduced.

Additional comparative samples (CE-15 and CE-16) were prepared that, in addition to barbituric acid, also contained some amine (HPA or MEA) during the surfactant pre-treatment. After the pre-treatment, the surfactant mixtures were further mixed with the other components of the formulated polyol as listed in Table 4: the trioxocane content in the formulated polyol was tested immediately after.

These experiments aim to reproduce a situation where the barbituric acid is added directly to the formulated polyol, which typically also contains the amine catalyst. It is shown that the presence of the amines (MEA or HPA-X) reduces the effectiveness of the barbituric acid, leading to higher trioxocane amount when compared with IE-12.

TABLE 4
Polyol formulations using untreated Niax ™ L650 vs pre-treated Niax ™ L650

| | CE -14 | IE-12 | CE-15 | CE-16 |
|---|---|---|---|---|
| Polyol 4 | 100 | 100 | 100 | 100 |
| H₂O | 4.6 | 4.6 | 4.6 | 4.6 |
| Niax ™ L650 | 1.6 | | | |
| Niax ™ L650, 1.6 part, pre-treated with 0.08 | | 1.6 | | |
| parts of BA, and aged for 12 hours at 22 deg C. | | | | |
| Niax ™ L650, 1.6 parts, pre-treated with 0.08 | | | 1.6 | |
| parts of BA and with 0.08 parts HPA-X, | | | | |
| aged for 12 hours at 22 deg C. | | | | |
| Niax ™ L650, 1.6 parts, pre-treated with 0.08 | | | | 1.6 |
| parts of BA and with 0.08 parts MEA, | | | | |
| aged for 12 hours at 22 deg C. | | | | |
| JEFFCAT ™ ZR50 | 0.21 | 0.21 | 0.21 | 0.21 |
| Catalyst T9 | 0.28 | 0.28 | 0.28 | 0.28 |
| Trioxocane in the formulated polyol (ppb) | 5.3 | 1.0 | 2.00 | 3.0 |

The formulated polyols from Table 4 were then used for preparing Flex PU foam by reaction with isocyanate 1, and the resulting foams were then tested for residual trioxocane. Results are reported in Table 5, confirming the lower trioxocane content in IE-12 corresponding to the foam that was prepared using Niax™ L650 pretreated with only BA.

TABLE 5
Trioxocane levels in foam samples using untreated
Niax L650 vs pre-treated Niax L650

| | CE-14 | IE-12 | CE-15 | CE-16 |
|---|---|---|---|---|
| Polyol 4 | 100 | 100 | 100 | 100 |
| H₂O | 4.6 | 4.6 | 4.6 | 4.6 |
| Niax L650 | 1.6 | | | |
| Niax L650, 1.6 part, pre-treated with 0.08 | | 1.6 | | |
| parts BA, and aged for 12 hours at 22 deg C. | | | | |
| Niax L650, 1.6 parts, pre-treated with 0.08p | | | 1.6 | |
| arts BA and with 0.08 parts HPA-X, aged | | | | |
| for 12 hours at 22 deg C. | | | | |
| Niax L650, 1.6 parts, pre-treated with 0.08 | | | | 1.6 |
| parts BA and with 0.08 parts MEA, aged | | | | |
| for 12 hours at 22 deg C. | | | | |
| JEFFCAT ™ ZR50 | 0.21 | 0.21 | 0.21 | 0.21 |
| Catalyst T9 | 0.28 | 0.28 | 0.28 | 0.28 |
| Isocyanate 1 | 58.4 | 58.4 | 58.4 | 58.4 |
| Trioxocane in the foams (ppb) | 31 | 20 | 37 | 37 |

Consequently, the present disclosure provides an effective solution to degrade the unsaturation in odorous products such as SPE and polyols, and decrease the level of cyclic ethers from the very beginning at raw material stage, leading to a consistently improved flex PU foam quality with fewer odors.

What is claimed is:

1. A process of pre-treatment of an odorous product selected from the group consisting of a polyether polyol product, an SPE surfactant product and a combination thereof, comprising, adding an acidic agent with aldehyde abatement capability to the product, wherein the acidic agent has the structure of formula (1): 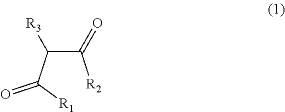
wherein R₁ and R₂ are individually selected from the group consisting of —OH, —NH, —NH₂, and a C₁₋₁₀ alkyl unsubstituted or substituted with at least one substituent selected from the group consisting of a halogen, —OH, —NH, —NH₂, —OSO₃H, —SO₃H, —COOH, —OPO(OH)₂, a C₁-C₆ alkyl, a C₁-C₆ alkoxy, and a C₃-C₆ alicyclic or aromatic ring whose carbon atom(s) is optionally replaced with at least one hetero atom selected from the group consisting of N, O and S; or optionally, R₁ and R₂ are linked by a single bond or a divalent linker group to form a cyclic structure;
with the proviso that at least one of R₁ and R₂ comprises at least one proton-releasing group selected from the group consisting of —OH, —NH, —NH₂, —OSO₃H, —SO₃H, —COOH, and —OPO(OH)₂; and, when the at least one proton-releasing group is —NH or —NH₂, it is adjacent to at least one electron-drawing group, and
wherein R₃ is H, or an unsubstituted or a substituted C₁₋₁₀ alkyl group.

2. The process according to claim 1, wherein the amount of the acidic agent added to the odorous product is from 0.01% to 1.00% by weight of the odorous product.

3. The process according to claim 1, wherein R₁ and R₂ are linked by a divalent linker group to form a cyclic structure, wherein the divalent linker group is selected from the group consisting of —C(O)—, —C(O)O—, —S(O)₂— and a C₁-C₄ alkylene.

4. The process according to claim 1, wherein the acidic agent comprises an acidic cyclic ureide compound.

5. The process according to claim 1, wherein the acidic agent has a pKa of from 2.0 to 5.0.

6. The process according to claim 1, wherein the acidic agent has a molar weight of from 80 to 2,000 g/mol.

7. The process according to claim 1, wherein the acid agent comprises barbituric acid.

8. The process according to claim 1, wherein the pre-treatment is performed before the product is used as a raw material in downstream applications.

9. The process according to claim 1, wherein the polyether polyol has a hydroxyl equivalent weight of at least 800 and a PO content of greater than 50%.

10. A polyurethane composition, comprising,
(A) a polyol component comprising one or more polyols selected from the group consisting of a polyester polyol, a polyether polyol, and the combination thereof, and
(B) an isocyanate component comprising one or more isocyanate compounds,
wherein the polyol component (A) comprises a pre-treated product obtained by the process according to claim 1.
